(19) United States
(12) Patent Application Publication
(10) Pub. No.: US 2011/0044559 A1
(43) Pub. Date: Feb. 24, 2011

(54) IMAGE ARTIFACT REDUCTION

(75) Inventors: Klaus Erhard, Hamburg (DE); Peter Forthmann, Sandesneben (DE); Roland Proksa, Hamburg (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/989,794

(22) PCT Filed: May 4, 2009
(86) PCT No.: PCT/IB2009/051812

§ 371 Date: Oct. 27, 2010

Related U.S. Application Data
(60) Provisional application No. 61/050,801, filed on May 6, 2008.
(60) Provisional application No. 61/084,783, filed on Jul. 30, 2008.
(60) Provisional application No. 61/087,194, filed on Aug. 8, 2008.

(51) Int. Cl. G06K 9/40

(52) U.S. Cl. 382/275

(57) ABSTRACT

A method includes generating simulated complete projection data based on acquisition projection data, which is incomplete projection data, and virtual projection data, which completes the incomplete projection data and reconstructing the simulated complete projection data to generate volumetric image data. An alternative method includes supplementing acquisition image data generated from incomplete projection data with supplemental data to expand a volume of a reconstructable field of view and employing an artifact correction to correct a correctable field of view based on the expanded reconstructable field of view.

The following generally relates to reducing image artifacts and finds particular application to cone beam computed tomography (CT). However, it is also amenable to other medical imaging applications and to non-medical imaging applications.

A variety of exact reconstruction algorithms exist for cone beam computed tomography. Such algorithms are able to reconstruct attenuation image data of scanned structure of a subject or object substantially without cone beam artifacts such as streaks and/or intensity drops. Unfortunately, such algorithms are based on having complete projection data, and some scans such as circular trajectory axial cone beam scans generate incomplete projection data in that some of the regions of the scanned field of view are not adequately sampled in that there is at least one plane that intersects some region of the scanned field of view but does not intersect the source trajectory. As a consequence, the reconstructed images may suffer from cone beam artifact resulting from the strong z-gradients in the scanned structure.

One technique for reducing cone beam artifacts includes subtracting artifacts directly from the reconstructed image. Such a technique may include performing a first pass reconstruction to generate first image data, segmenting the first image data into several tissue types such as water, air, bone, etc., forward-projecting the segmented image data back into the acquisition geometry, performing a second pass reconstruction on the forward projected data to generate second image data, generating a difference image based on the segmented image data the second image data, and subtracting the difference image data from the acquisition image data using a suitable multiplicative factor and/or an additional possible filtering step to generated corrected image data. Unfortunately, the choice of the multiplicative factor as well as the choice of additional filtering is not straightforward.

Another technique includes extracting knowledge about gradients in the object or subject from the image data, and using that information to re-simulate cone-beam artifacts in a second pass in order to later eliminate the artifact from the image data by subtraction. Unfortunately, this correction is generally limited to a central sub-region of the scanned field-of-view, and the artifact generally increases with distance from the central plane.

With respect to applications involving scanning a moving object such as a human or animal, contrast based gated rotational acquisitions often are based on sparse or incomplete angular sampling in which data is not available or is missing for a portion of the angular sampling interval. The sparse angular sampling may limit the image quality of the reconstruction. For example, when using a single circular arc acquisition with a concurrently acquired ECG signal, the gating of the projection data leads to artifact such as streaks in the reconstruction volume. The artifacts may be overcome by performing multiple circular arc acquisitions. Unfortunately, this leads to longer acquisition times and an increased patient dose.

Aspects of the present application address the above-referenced matters and others.

According to one aspect, a method includes generating simulated complete projection data based on acquisition projection data, which is incomplete projection data, and virtual projection data, which completes the incomplete projection data and reconstructing the simulated complete projection data to generate volumetric image data.

According to another aspect, a method includes supplementing acquisition image data generated from incomplete projection data with supplemental data to expand a volume of a reconstructable field of view and employing an artifact correction to correct a correctable field of view based on the expanded reconstructable field of view.

According to another aspect, a system includes a projection data completer that generates simulated complete projection data based on acquisition incomplete projection data and virtual projection data that completes the acquisition incomplete projection data, and a reconstructor that reconstructs the simulated complete projection data to generate volumetric image data indicative thereof.

According to another aspect, a system includes an image data supplementor that supplements acquisition image data generated from incomplete projection data with supplemental data to expand a volume of a reconstructable field of view and a correction unit that employs an artifact correction algorithm to correct a correctable field of view that is based on the expanded reconstructable field of view.

The invention may take form in various components and arrangements of components, and in various steps and arrangements of steps. The drawings are only for purposes of illustrating the preferred embodiments and are not to be construed as limiting the invention.

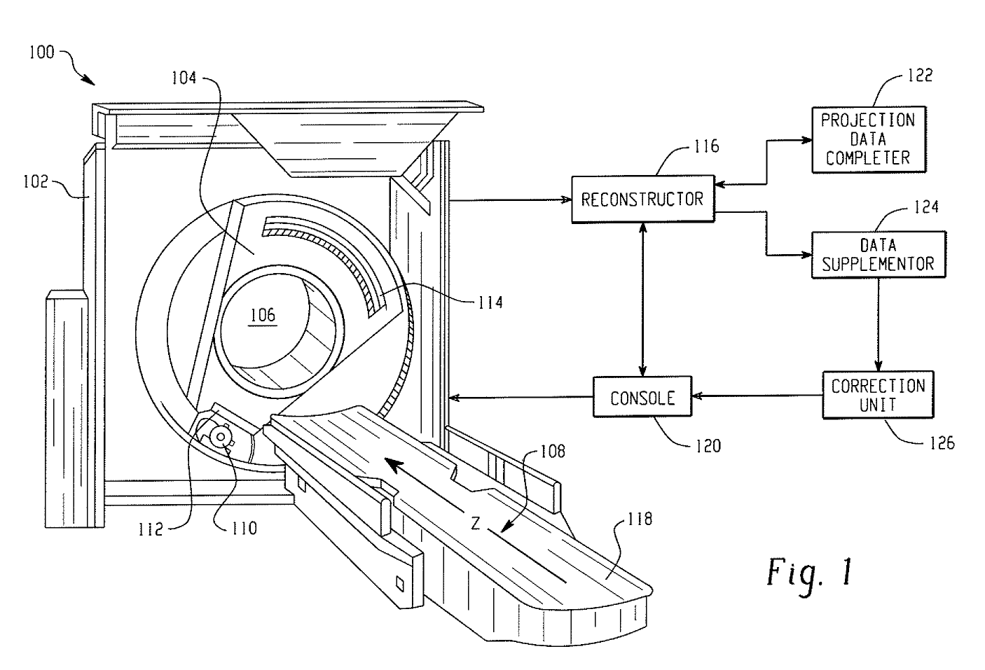

FIG. 1 illustrates an imaging system.

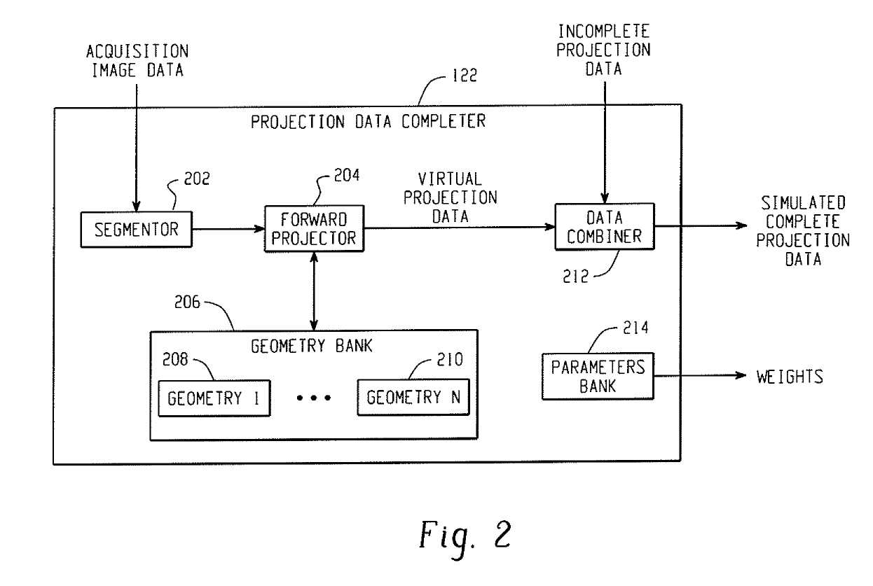

FIG. 2 illustrates an example projection data completer.

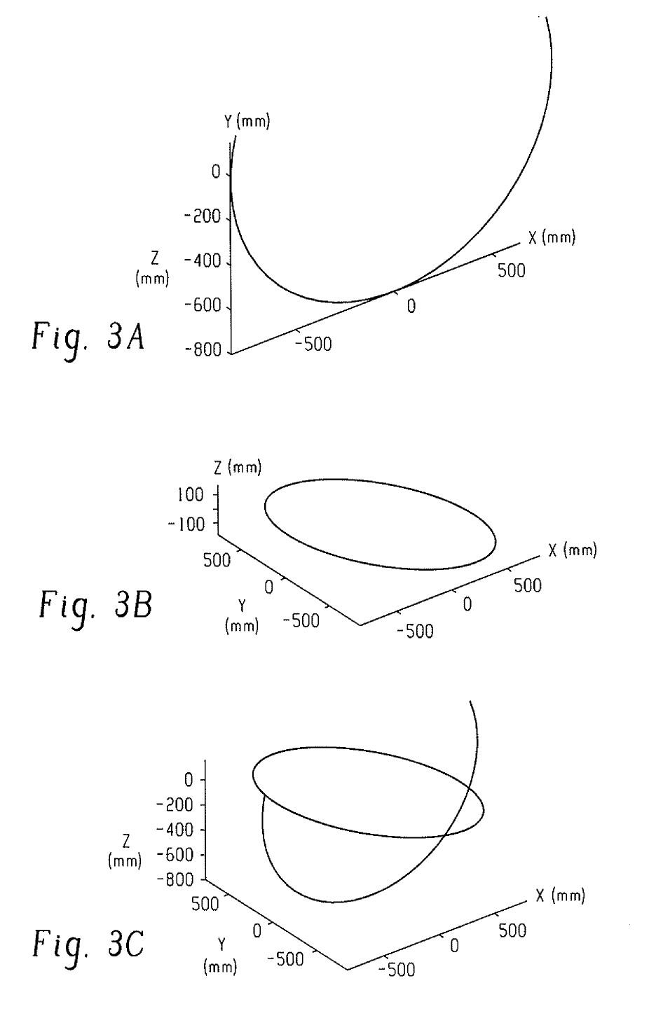

FIGS. 3A, 3B and 3C illustrate an example acquisition source trajectory and an example virtual source trajectory that completes the acquisition source trajectory.

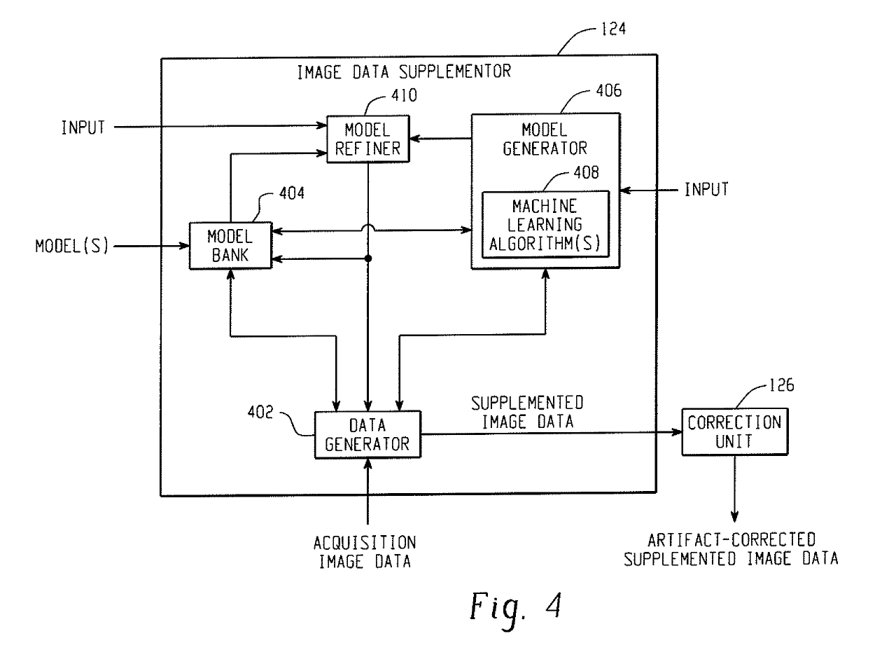

FIG. 4 illustrates an example image data supplementor.

FIG. 5 illustrates an example anthropomorphic model.

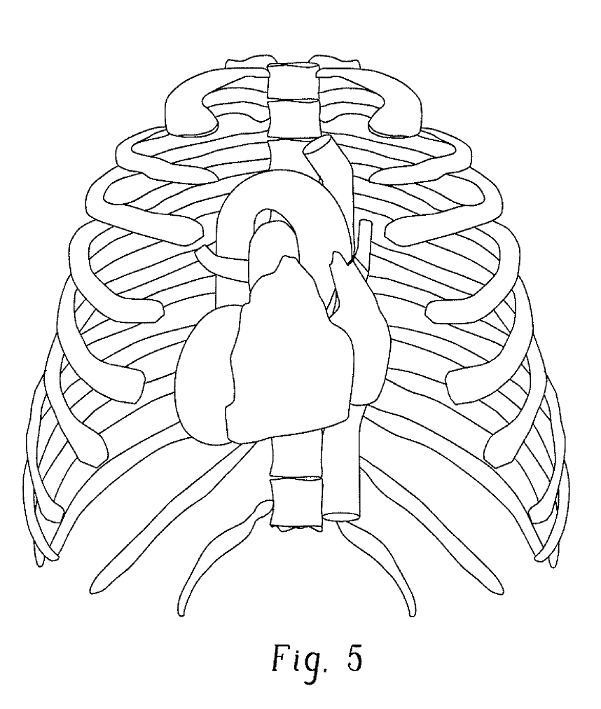

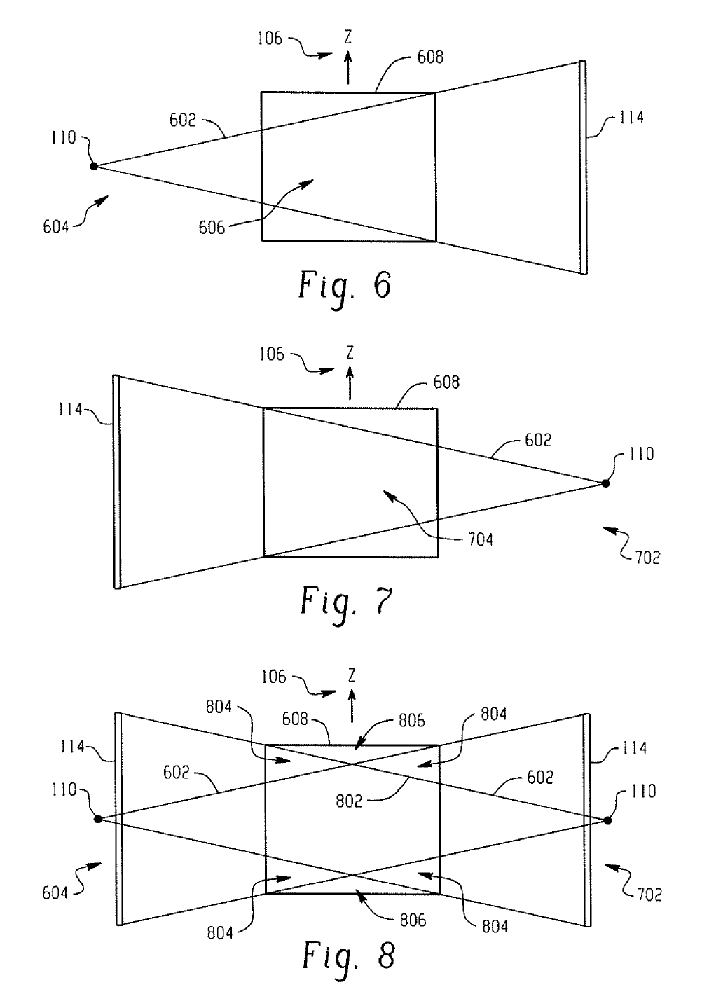

FIGS. 6-9 illustrate an example reconstructable field of view.

FIGS. 10 and 11 illustrate an example correctable field of view.

FIG. 12 illustrates an expanded correctable field of view.

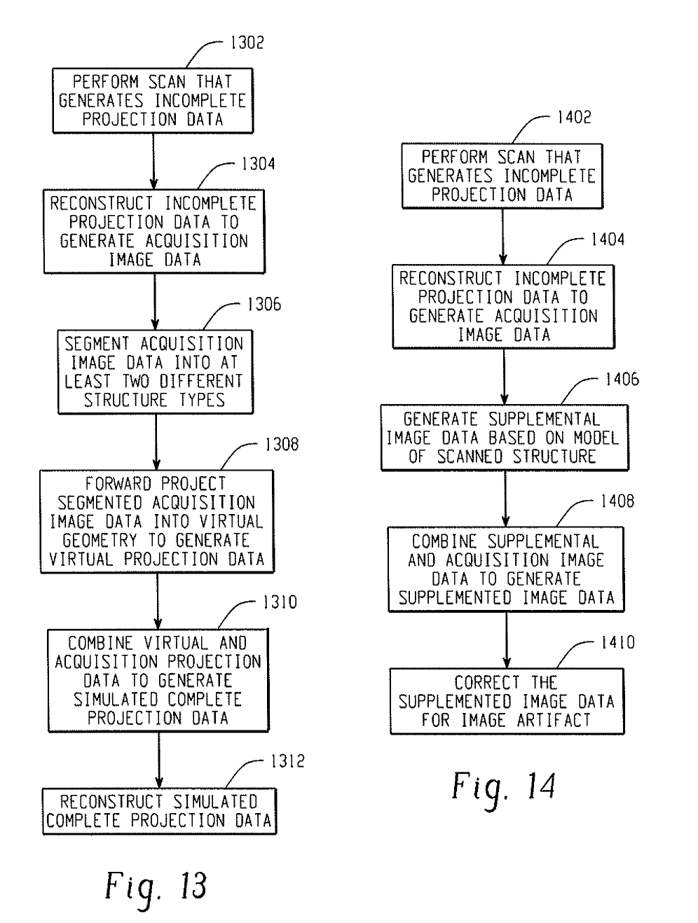

FIG. 13 illustrates an example method.

FIG. 14 illustrates an example method.

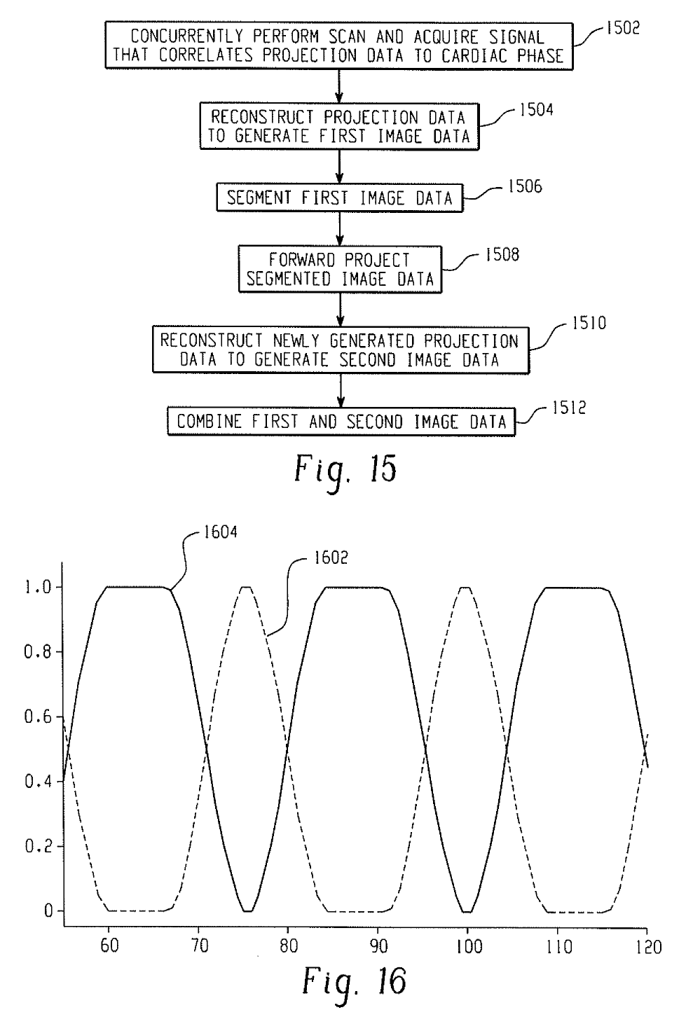

FIG. 15 illustrates an example method.

FIG. 16 illustrates an example conjugate gating window function.

FIG. 1 illustrates an example medical imaging system 100 that includes a stationary gantry 102 and a rotating gantry 104, which is rotatably supported by the stationary gantry 102. The rotating gantry 104 rotates around an examination region 106 about a longitudinal or z-axis 108.

A radiation source 110 is supported by and rotates with the rotating gantry 104 around the examination region 106 about a z-axis. The radiation source 110 travels along a source trajectory such as a circular or other source trajectory and emits radiation that traverses the examination region 106. A collimator 112 collimates the emitted radiation to produce a generally conical, fan, wedge, or other shaped radiation beam.

A radiation sensitive detector array 114 detects photons that traverse the examination region 106 and generates projection data indicative thereof. A reconstructor 116 reconstructs the projection data and generates volumetric image data indicative of the examination region 106.

A patient support 118, such as a couch, supports the patient for the scan. A general purpose computing system 120 serves as an operator console. Software resident on the console 120 allows the operator to control the operation of the system 100. Such control may include selecting a protocol that employs an incomplete projection data artifact correction algorithm to correct for artifact associated with reconstructing an incomplete projection data.

The scanner 100 can be used to perform various acquisitions. In one instance, the scanner 100 is used to perform an acquisition in which incomplete projection data is generated. An example of such an acquisition includes, but is not limited to, a circular trajectory, axial cone beam scan.

In one embodiment, a projection data completer 122 completes the incomplete projection data with virtual projection data to generate complete projection data. As described in greater detail below, this can be achieved by expanding the incomplete projection data in radon space through extrapolation or otherwise to generate missing data that completes the incomplete projection data. This resulting simulated complete projection data can be used to generate an image with an image quality about the same as an image quality of an image generated with complete projection data obtained during acquisition.

In an alternative embodiment, a data supplementor 124 supplements the image data generated with the incomplete projection data. As described in greater detail below, this can be achieved based on a model indicative of the scanned object or subject in which the model is registered to the image data and used to determine structure absent in the image data. A correction unit 126 corrects the supplemented image data for incomplete projection data artifacts such as cone beam artifacts. Supplementing the data as such allows for a correction of a larger portion of the field of view relative to a configuration in which the image data is not supplemented.

FIG. 2 illustrates an example embodiment of the projection data completer 122. A segmentor 202 segments the acquisition image data reconstructed from incomplete projection data. The segmentor 202 segments the image data into a plurality of different tissue types such as, but not limited to, water, air and bone. Generally, the tissue types are selected so that the structures creating artifacts, for example, structures that generate high z-gradients, are maintained while the artifact is essentially eliminated. In one instance, the segmentor 202 automatically segments the image data based on a histogram analysis of the image data. In another instance, the segmentor 202 employs a threshold technique that separates the Hounsfield scale into a plurality of disjoint intervals, and each interval is assigned a constant Hounsfield value such as the value of the midpoint of the interval or other point of the interval. Manual segmentation techniques based on user input are also contemplated herein.

A forward projector 204 forward projects the segmented image data into a suitable geometry, including a geometry that is different from the acquisition geometry. A geometry bank 206 includes N different virtual geometries 208 and 210, where N is in integer. A suitable virtual geometry includes a virtual geometry having a source trajectory that completes the incomplete projection data. For instance, a suitable trajectory includes a trajectory that when combined with the acquisition trajectory intersects every plane that intersects the field of view. A suitable geometry may also be dynamically determined, automatically and/or based on user input, when needed.

By way of non-limiting example, where the acquisition geometry includes a circular trajectory, a suitable virtual geometry may include a geometry with a line trajectory, another circle trajectory that is orthogonal to the plane of the acquisition trajectory, a spiral trajectory, a saddle trajectory, etc. FIGS. 3A and 3B show non-limiting examples, respectively, of a circular arc acquisition trajectory of 240 degrees, which results in incomplete projection data, and an orthogonal circle virtual trajectory that completes the circular arc acquisition trajectory. FIG. 3C shows a superposition of trajectories of FIGS. 3A and 3B. The axes in the figures represent distance in units of millimeters (mm).

Returning to FIG. 2, a data combiner 212 combines the acquisition projection data and the virtual projection data to generate simulated complete projection data, which can be reconstructed in a second or subsequent reconstruction. The influence of the virtual projection data on the reconstruction can be controlled with weighting functions W1 for the acquisition projection data and W2 for the virtual projection data, which are based on Radon transformed data, for example, the weights are related to the number of intersections of one particular plane with the source and the virtual trajectory. In one instance, the virtual projection data is used only where acquisition projection data is absent. In this instance, suitable weights include W1=1 and W2=0 where acquisition projection data is available and W1=0 and W2=1 where acquisition projection data is not available. Other weights can be used, for example, in another embodiment, suitable weights include W1=0.75 and W2=0.25 or some other combination. In the illustrated example, such weights are stored in a parameter bank 214.

The generated simulated complete projection data is reconstructed by the reconstructor 116 or otherwise based on the weights using a suitable reconstruction algorithm. An example of a suitable reconstruction algorithm includes, but is not limited to, an exact reconstruction algorithm such as an exact reconstruction algorithm for piecewise differentiable source trajectories. Other exact reconstruction algorithms can alternatively be used.

As noted above, by completing the incomplete projection data, the image quality of an image generated with the simulated completed incomplete projection data is about the same as the image quality of an image generated with complete projection data during acquisition.

It is to be appreciated that virtual projection data can be also be generated for other applications. For instance, the above approach can be used to generate virtual data such as cardiac phase data for a cardiac scan for phases outside of the gating window and/or other virtual data for other applications.

FIG. 4 illustrates an example of a non-limiting embodiment of the data supplementor 124. A data generator 402 generates supplemental data in connection with acquisition image data generated with incomplete projection data. In the illustrated example, the data generator 402 generates the supplemental data based on a model indicative of the scanned structure of the scanned object or anatomy. For example, where the scanned anatomy is a particular organ (e.g., heart, spine, liver, etc.), the model used can be a model indicative of anatomy the includes the organ such as the example anthropomorphic model shown in FIG. 5 or a module indicative only of the organ.

The data generator 402 registers or fits the model with the acquisition image data to map the anatomical or structural information in the model to the anatomical or structural information in the acquisition image data, which also maps the anatomical or structural information in the model that is missing in the acquisition image data to the acquisition image data. The registration may include an iterative approach in which the registration is adjusted until a similarity measure and/or other criteria is satisfied. Optionally, an operator may also manually adjust the registration. When registered, anatomical or structural information in the model that is not in the acquisition image data can be generated for the acquisition image data based on the registered model.

The model used by the data generator 402 may be either an existing model pre-stored in a model bank 404 or a model dynamically generated by a model generator 406. Such a model can be general or specific to the scanned object or subject. An example general model may be an abstraction based on a priori knowledge of what the object or subject should look like. The a priori knowledge may include information obtained from literature, previous procedures performed on the object or subject (e.g., a mean or actual passed representation), other similar object or subjects, and/or other information. The abstraction may be graphical and/or a mathematical equation. An example of a specific model includes a model based on information about the scanned object or subject.

One or more of the models stored in the model bank 404 may have been up/down loaded from an external model source to the model bank 404, generated by the model generator 406, and/or otherwise provided.

The model generator 406 can use various approaches to generate a model. For example, the illustrated model generator 406 includes one or more machine learning algorithms 408, which allows the model generator 406 to leverage information such as historical information, patterns, rules, etc. to generate models through computational and statistical methods using classifiers (inductive and/or deductive), statistics, neural networks, support vector machines, cost functions, inferences, etc. By way of example, the algorithms 408 may use input such as size, shape, orientation, location, etc. of the object or a similar object, anatomy of the subject or one or more different subjects, previously generated models, and/or other information to generate a model for the scanned object or subject. Moreover, the model generator 406 may use an iterative approach wherein the model is refined over two or more iterations.

A model refiner 410 can be used to generate a model specific to the scanned object or subject based on a general model and information corresponding to the object or subject. For instance, the model refiner 410 can use information indicative of a size, shape, orientation, location, etc. of the object or anatomy to modify the general model to be more specific to the object or subject. In one embodiment, the model refiner 410 is omitted or not used.

A correction unit 126 corrects the supplemented image data for artifact. In this example, the correction unit 126 employs a multi-pass reconstruction technique such as a subtraction based reconstruction technique. One such technique includes segmenting supplemented image data into several tissue types such as water, air, bone and/or one or more other tissue types associated with a high gradient tissue interface, forward projecting the segmented image data into the acquisition geometry, reconstructing the forward-projected segmented image data to generated second image data, generating an image data that emphasizes the artifact based on the difference between the segmented image data and the second image data, and subtracting the difference image data from the supplemented image data to correct the supplemental imaged data for incomplete data artifact. Other artifact correction techniques may alternatively be used.

Without the supplemental data, the correction unit 126 may only be able to correct a sub-portion of the acquisition image data. This is illustrated in connection with a circular trajectory axial cone beam scan and FIGS. 6-11.

Initially referring to FIG. 6, the radiation source 110 emits radiation 602 from a first angular position 604 along a circular trajectory about the z-axis 106. At the position 604, the radiation 602 traverses a first sub-portion 606 of an illuminated field of view 608 and is detected by the detector array 114. FIG. 7 depicts the radiation source 110 emitting the radiation 602 from a second angular position 702, which is about 180 degrees away from the first angular position 604 on the circular trajectory. At the second position 702, the radiation 602 traverses a second sub-portion 704, which is different from the first sub-portion 606, of the illuminated field of view 608 and is detected by the detector array 114.

FIG. 8 illustrates a superposition of FIGS. 6 and 7. In FIG. 8, a third sub-portion 802 of the illuminated field of view 608 represents the portion of the illuminated field of view 608 through which the radiation 602 traverses as the radiation source 110 travels along the circular trajectory. For sub-portions 804 and 806 of the illuminated field of view 608, at some angular positions of the source 110 (e.g., 604 and 702) the radiation 602 does not traverse one or more of the sub-portions 606 and 704 and, thus, data is missing for reconstruction purposes for the sub-portions 606 and 704. As a consequence, the third sub-portion 802 of the illuminated field of view 608 represents a reconstructable field of view 802.

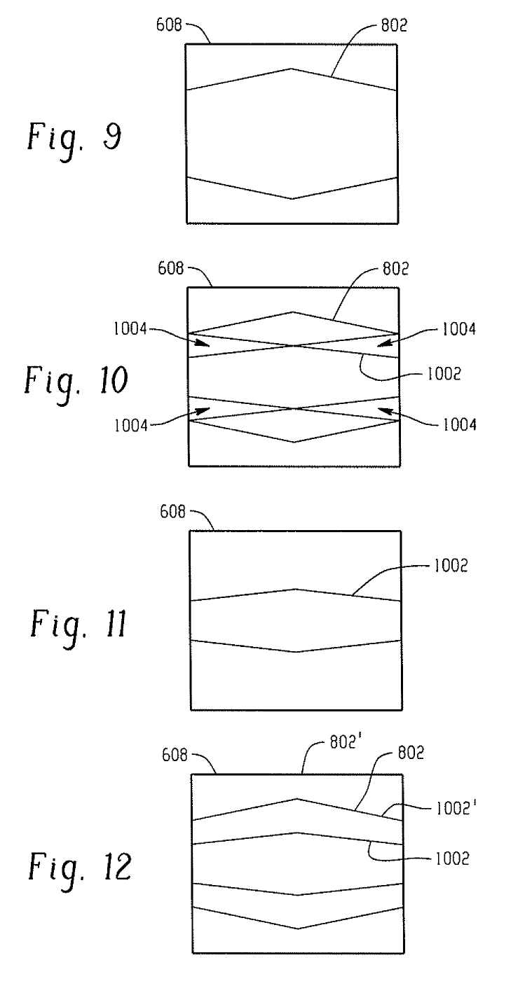

For sake of clarity, FIG. 9 shows the reconstructable field of view 802, with respect to the illuminated field of view 608, without showing the source 110, the detector array 114, or the radiation beam 602. As shown, the reconstructable field of view 802 represents a sub-portion of the illuminated field of view 608. FIG. 10 additionally shows a correctable field of view 1002 for the reconstructable field of view 802. The correctable field of view 1002 is defined by the reconstructable field of view 802 and includes a sub-portion of reconstructable field of view 802 where image data is available to be forward-projected to generate projection data for a subsequent reconstruction. As such, sub-portions 1004 are not part of the correctable field of view 1002. For sake of clarity, FIG. 11 shows only the correctable field of view 1002 with respect to the illuminated field of view 608. As shown, the correctable field of view 1002 represents a sub-portion of the reconstructable field of view 802.

FIG. 12 shows a correctable field of view 1002′ for the supplemented image data. As illustrated, in FIG. 12 the supplemental data effectively increases the volume of the reconstructable field of view 802 to 802′ (a volume substantially equal to the volume of the illuminated field of view 608), thereby increasing the volume of the correctable field of view 1002 to 1002′ (a volume substantially equal to the volume of the reconstructable field of view 802). As such, the correction unit 126 can correct the entire reconstructable field of view 802 of the image data by extending the reconstructable field of view 802 to the dimensions of the illuminated field of view 608, which extends the correctable field of view 1002 to the dimensions of the reconstructable field of view 802, through the addition of the supplemental data to the acquisition image data.

FIG. 13 illustrates a method for completing incomplete projection data. At 1302 a scan which results in incomplete projection data is performed. At 1304, the acquisition projection data is reconstructed to generate acquisition image data. At 1306, the acquisition image data is segmented in to two or more structure types. At 1308, the segmented image data is forward projected in a virtual geometry that includes a virtual source trajectory that completes the acquisition trajectory to generated virtual projection data. At 1310, the forward projected data is combined with the incomplete projection data to generate simulate complete projection data. As 1312, the simulated complete projection data is reconstructed using suitable weights for the acquisition and virtual projection data.

FIG. 14 illustrates a method for extending the correctable field of view of image data. At 1402 a scan which results in incomplete projection data is performed. At 1404, the acquisition projection data is reconstructed to generate acquisition image data. At 1406, supplemental data is generated based on the acquisition image data and a model of the scanned object or subject, where the supplemental data represents structure in the model that is absent in the acquisition image data. At 1408, the supplemental data is combined with the acquisition image data to form supplemented image data, which increases or extends the reconstructable field of view so that the correctable field of view is about equal in dimension to the reconstructable field of view. At 1410, the correctable field of view is corrected for incomplete projection data artifact, including circular trajectory axial cone-beam artifacts.

In another embodiment, virtual projection data is generated for a moving object. For explanatory purposes, the following is described in connection with the heart, for example, generating virtual projection data for a cardiac phase in connection with a cardiac application. However, it is to be understood that the object can be any object that moves while being imaged. This embodiment is described with respect to FIGS. 15 and 16.

Initially referring to FIG. 15, at 1502 a rotational arc acquisition is performed and information used to map or correlate the projection data to a cardiac phase of the heart is concurrently acquired. The acquisition may be performed while the vessels and/or chambers of interest of the heart are filled with contrast agent, and the information can be electrocardiogram (ECG) and/or other information that correlates the projection data to a cardiac phase. Generally, such an acquisition yields a sparse angular sampling and results in incomplete data, which may result in streaks in the reconstructed data.

At 1504, first image data is generated for the cardiac phase, which may be a relatively low motion (resting) or other phase of the cardiac cycle. In this example, the first image data is a three dimensional reconstruction generated using a gated filtered backprojection reconstruction algorithm using a first gating window. In one instance, the first gating window represents a pre-set range around the phase of interest, and may be weighted such that the data closer to a center region of the window contributes to a greater extent than the data farther from the center region. FIG. 16 shows an example first weighting function 1602. In this example, the weighting function is a cos² weighting function with a window width that is 75% of the cardiac cycle.

At 1506, the first image data is segmented into two or more different types of tissue. Suitable tissue types include, but are not limited to, air, water, bone, contrast-agent, etc. As noted above, in one instance the selected tissue types often correspond to the structures creating artifacts, for example, structures that generate high z-gradients. Likewise, the segmentation can be based on a histogram analysis of the image data, a threshold technique that separates the Hounsfield scale into a plurality of disjoint intervals, and/or other segmentation technique. In one non-limiting instance, the projections of the segmentation are filtered, for example, with a Gaussian, median or other filter, which may smooth the reconstruction.

At 1508, the segmented image data is forward projected. The segmented image data can be forward projected into the acquisition geometry or a virtual geometry. In one embodiment, the segmented image data is forward projected into views of the cardiac phase that have not been measured, thereby extrapolating or filling in missing data in the acquisition angular sampling interval.

At 1510, the newly generated projection data is reconstructed to generate second image data. In this example, the second image data is a three dimensional reconstruction generated using a gated filtered backprojection reconstruction algorithm using a second gating window. FIG. 16 shows an example second weighting function 1604. In this example, the second weighting function is the conjugate of the first weighting function, or equal to one minus the first weighting function (1−first weighting function).

At 1512, the first and second image data are combined to form third image data. In one instance, the first and second image data are combined as a function of Equation 1:

Third image data=A(first image data)+B(second image data), Equation 1:

wherein A and B are weighting functions. The weights functions A and B can be variously selected. In one instance, A=B=0.5. In another instance, the weights A and B are not equal. In yet another instance, the sum of the weights does not equal one. It is to be appreciated that the resulting third image data may have less artifacts than the first image data and increased signal to noise and contrast to noise ratios. The above may be implemented by way of computer readable instructions, which, when executed by a computer processor(s), causes the processor(s) to carry out the acts described herein. In such a case, the instructions are stored in a computer readable storage medium such as memory associated with and/or otherwise accessible to the relevant computer.

It is to be appreciated that the approaches herein are applicable to other imaging applications, including, but not limited to CT system operated in circular mode, a C-arm system that acquires incomplete data along a planar source trajectory, and/or any other imaging application in which an incomplete set of projection data is generated.

The invention has been described with reference to the preferred embodiments. Modifications and alterations may occur to others upon reading and understanding the preceding detailed description. It is intended that the invention be constructed as including all such modifications and alterations insofar as they come within the scope of the appended claims or the equivalents thereof.

1-9. (canceled)

10. A method, comprising:
supplementing acquisition image data generated from incomplete projection data with supplemental data to expand a volume of a reconstructable field of view; and
employing an artifact correction to correct a correctable field of view based on the expanded reconstructable field of view.

11. The method of claim 10, wherein the expanded reconstructable field of view has a volume about equal to a volume of an illuminated field of view, and the correctable field of view has a volume about equal to the reconstructable field of view, and the reconstructable field of view is a sub-portion of the illuminated field of view.

12. The method of claim 10, further including:
generating the supplemental data based on a model of the scanned object or subject.

13. The method of claim 12, wherein the model is general to the scanned structure or anatomy or specific to the scanned object or subject.

14. The method of claim 12, further including:
registering the model to the acquisition image data, wherein the supplemental data corresponds to structure or anatomy of the scanned object or subject that is in the model but absent in the acquisition image data.

15. The method of claim 10, wherein the correction is a second pass cone beam artifact correction.

16. The method of claim 10, further including:
combining the supplemental data and the acquisition data to generate supplemented image data; and
correcting the supplemented image data.

17-19. (canceled)

20. A system, comprising:
an image data supplementor that supplements acquisition image data generated from incomplete projection data with supplemental data to expand a volume of a reconstructable field of view; and
a correction unit that employs an artifact correction algorithm to correct a correctable field of view that is based on the expanded reconstructable field of view.

21. The system of claim 20, further including:
a data generator that generates the supplemental data based on the acquisition data and a model of scanned structure.

22. The system of 21, wherein the model is general or specific to the scanned structure.

23. The system of claim 20, wherein the supplemental data represents scanned structure in the model and absent in the acquisition image data.

24. The system of claim 20, wherein the correction includes a second pass cone beam artifact correction.

25. The system of claim 20, wherein the expanded reconstructable field of view has a volume about equal to a volume of an illuminated field of view, and the correctable field of view has a volume about equal to the reconstructable field of view, and the reconstructable field of view is a sub-portion of the illuminated field of view.

26. A method, comprising:
concurrently imaging a moving object and acquiring a signal indicative of a movement cycle of the object;
selectively reconstructing a sub-portion of first projection data that corresponds to a desired phase of the movement cycle to generate first image data, wherein the sub-portion is determined based on the movement cycle;
segmenting the first image data into at least two different structure types;
forward projecting the segmented image data to generate second projection data, which corresponds to the desired phase and is absent from the first projection data;
reconstructing the second projection data to generate second image data; and
combining the first and second image data to generate third image data.

27. The method of claim 26, wherein the first projection data is reconstructed using a first gating function, and the second projection data is reconstructed using a second gating function, wherein the second gating function is the conjugate of the first gating function.

28. The method of claim 27, wherein the first weighting function is a cos² weighting function with a window width that is about 75% of the movement cycle.

29. The method of claim 26, wherein the act of forward projecting includes forward projecting the second image data into the acquisition geometry.

30. The method of claim 26, wherein the act of forward projecting includes forward projecting the second image data into a virtual geometry.

31. The method of claim 26, wherein the act of forward projecting includes forward projecting the second image data into a geometry so as to generate projection data for the desired phase that is absent from the acquisition projection data for the desired phase.

32. The method of claim 26, wherein the act of combining the first and second image data to generate third image data includes applying a first weight to the first image data and applying a second weight to the second image data.

33. The method of claim 26, wherein the first and second projection data are reconstructed using a gated filtered backprojection reconstruction algorithm with a weighted gating window.

34. The method of claim 33, wherein the weighted gating window applies a relatively higher weight to data corresponding to a center region of the window.

35. The method of claim 26, wherein the signal is an ECG signal.

36. The method of claim 26, wherein the object is a human or animal heart.
